(19) United States
(12) Patent Application Publication
(10) Pub. No.: US 2003/0128408 A1
(43) Pub. Date: Jul. 10, 2003

(54) Image forming apparatus

(75) Inventor: Beniko Matsumoto, Tokyo (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/036,526

(22) Filed: Jan. 7, 2002

(51) Int. Cl. H04N 1/46

(52) U.S. Cl. 358/500

(57) ABSTRACT

In carrying out a copy operation, the optimum operation mode for image data read by a scanner is determined. This operation mode is shown to a user. When a command is given to change the operation mode to the shown operation mode, this operation mode is set, otherwise, an operation mode told by the user is set.

### BACKGROUND OF THE INVENTION

The invention relates to an image forming apparatus, such as a full-color copying machine, that has a color scanner and a color printer or an image forming system having a color scanner and a color printer.

Conventionally, as an image forming apparatus that outputs color images, a so-called 4-series tandem type full-color copying machine is known which is provided along a carrier belt with four image forming units that form tonor images of colors of yellow (Y), magenta (M), cyan (C) and black (BK) on the basis of color-decomposed image signals.

The image forming unit for each color has a photosensitive drum arranged to roll in contact with the carrier belt, an electrifying device for electrifying the drum surface to a given potential, an exposure device for exposing the drum surface to form an electrostatic latent image, a development device for supplying tonor to the electrostatic latent image on the drum surface to develop it, and a transfer device for transferring the developed tonor image to a sheet of recording paper carried in a state of being attracted to the carrier belt. The sheet of recording paper attracted to the carrier belt is transported through the four image forming units (process units) where the tonor images of the respective colors are transferred to the sheet of recording paper so that they are superimposed upon each other. The sheet of recording paper is then fed into a fixing device where the tonor images of the respective colors are fixed to the sheet of recording paper, whereby a color image is formed.

Such a quadruple-tandem color copying machine is composed of a scanner unit, a printer unit, an image processing unit, an image compression unit, an image decompression unit, and a hard disk drive (HDD).

Recently, color copying machines have made various operation modes possible. To make such operation modes possible, the color copying machines retain image data on an HDD prior to the print operation.

In general, color images are large in the amount of data. For this reason, the color copying machines perform compression processing in retaining the image of an original document read by the scanner unit on the HDD unless a command is given by the user at the time of a copying operation. The compressed image data stored on the HDD is decompressed and then formed on an image formed medium. However, the compression and decompression of image data will result in image degradation.

In contrast to this, a copy operation with no compression processing on image data is free of image degradation; however, since an enormous amount of data is involved, it takes a long time to store image data on the HDD.

That is, a copy operation with compression on image data allows the time required to store an image on the HDD and the time required by copying to be reduced, but on the other hand it has a demerit of image degradation.

In contrast, a copy operation without compression and decompression of image data results in an increase in the time required to store an image on the HDD and the time required by copying, but on the other hand it can provide high-quality printouts.

As described above, the conventional color copying machines are arranged to cause users to specify processing on image data. For this reason, it is difficult for users in general to find an operation mode most suitable for an original. Further, how to set an operation mode is also complicated.

### BRIEF SUMMARY OF THE INVENTION

It is an object of the invention to provide an image forming apparatus and an image forming method which are highly convenient for use and permit the optimum operation mode to be set with ease in carrying out a copy operation.

An image forming apparatus of the invention comprises: an operating unit for accepting an operation mode set command from a user; a scanner unit for reading an original document image optically and converting it into image data; an image determination section for determining the optimum operation mode for the image data read by the scanner unit; a display unit for, when the operation mode determined by the image determination section and the operation mode specified by the user differs from each other, showing the operation mode determined by the image determination section; a control unit for setting the operation mode determined by the image determination section when a command is given to change the operation mode to the operation mode shown on the display unit or setting the operation mode specified by the user through the operating unit when no command is given to change the operation mode to the operation mode shown on the display unit; an image forming unit for performing image formation processing on the original document image read by the scanner unit on the basis of the operation mode set by the control unit.

An image forming apparatus of the invention comprises: an operating unit for accepting an operation mode set command and a copy operation start command from a user; a scanner unit for reading an original document image optically and converting it into image data; a determination section for, when the copy operation start command is given through the operating unit, determining whether the document image read by the scanner unit is not suitable for compression and decompression; a display unit for, when the determination section determines that the document image is not suitable for compression and decompression, showing a guide to the effect that compression and decompression processing should not be performed on the document image if the operation mode set by the user involves compression and decompression; a control unit for setting an operation mode with no compression and decompression processing when it is told through the operating unit not to perform compression and decompression in accordance with the guide shown on the display unit and setting an operation mode with no compression and decompression processing when an operation mode with no compression and decompression processing is not told through the operating unit; an image forming unit for forming the original document image read by the scanner unit on an image formed medium on the basis of the operation mode set by the control unit.

An image forming method of the invention, which is adapted for use with an image forming apparatus comprising an operating unit for accepting an operation mode set command from a user, a scanner unit for reading an original document image optically and converting it into image data, and an image forming unit for forming the original document image read by the scanner unit on an image formed medium on the set operation mode, comprises the steps of: determining the optimum operation mode for the image data read by the scanner unit; when the determined operation mode differs from the operation mode specified by the user, showing the operation mode determined by the image determination section to the user; setting the shown operation mode when a command is given to change the operation mode to the shown operation mode or setting an operation mode specified in advance by the user when no command is given to change the operation mode to the shown operation mode; performing an operation of copying the original document image in the set operation mode.

An image forming method of the invention, which is adapted for use with an image forming apparatus comprising an operating unit for accepting an operation mode set command and a copy operation start command from a user, a scanner unit for reading an original document image optically and converting it into image data, and an image forming unit for forming the original document image read by the scanner unit on an image formed medium in a set operation mode, comprises the steps of: when the copy operation start command is given through the operating unit, reading the document image through the scanner unit and determining whether or not the document image is unsuitable for compression and decompression; when the determination is that the document image is unsuitable for compression and decompression, showing a guide to the effect that compression and decompression processing should not be performed on the document image if an operation mode set by the user involves compression and decompression; setting an operation mode with no compression and decompression processing when it is told through the operating unit not to perform compression and decompression in accordance with the guide shown and setting an operation mode with no compression and decompression processing when an operation mode with no compression and decompression processing is not told through the operating unit; and performing an operation of copying the original document image in the set operation mode.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a schematic sectional view of a color digital copying machine;

FIG. 2 is a schematic sectional view of the color digital copying machine;

FIG. 3 shows a display on a liquid crystal display unit;

FIG. 4 is a block diagram of the control system in the color digital copying machine;

FIG. 5 is a flowchart illustrating the execution of a copy operation after optimum settings have been made; and

FIG. 6 is a flowchart for the execution of a copy operation after the recommendation of copying without compression when an original image is not suitable for compression and decompression.

### DETAILED DESCRIPTION OF THE INVENTION

Hereinafter, an image forming apparatus embodying the invention will be described with reference to the drawings.

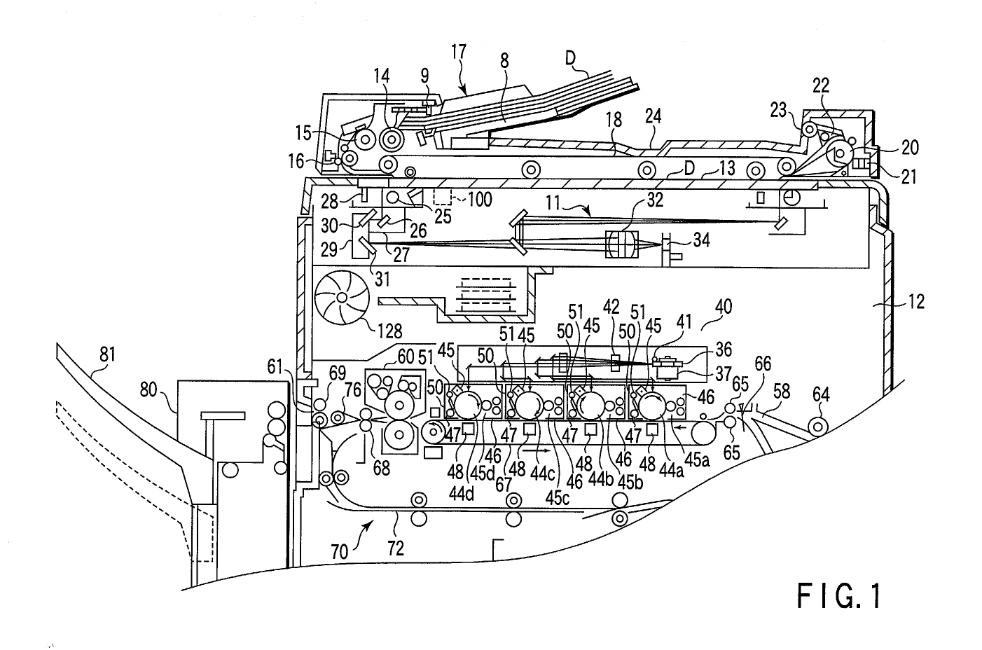

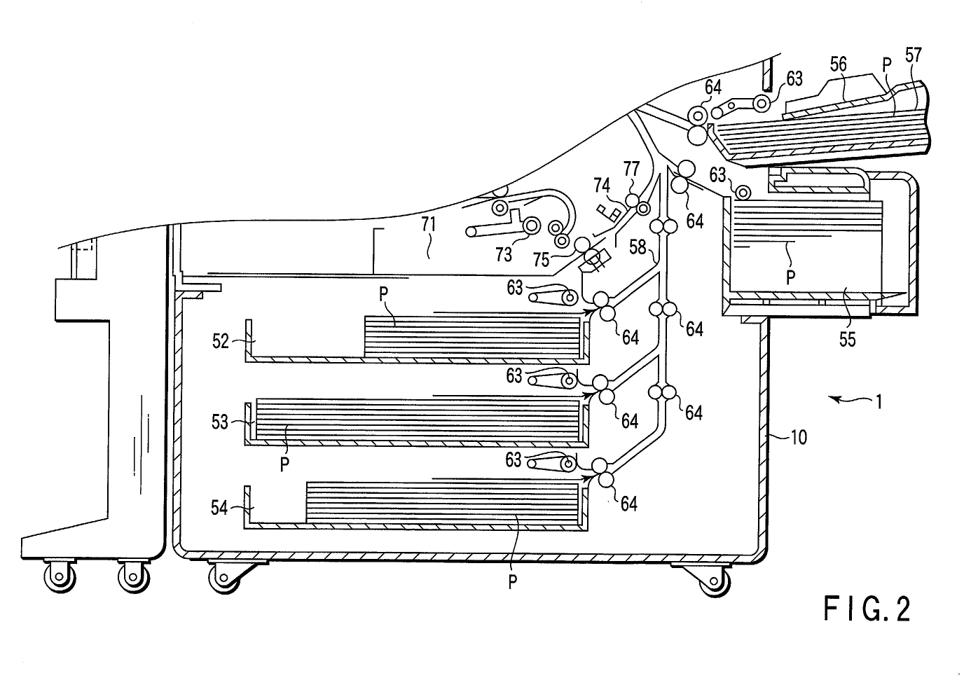

FIGS. 1 and 2 are sectional views of a color digital copying machine 1 as an example of an image forming apparatus of the invention.

As shown in FIGS. 1 and 2, the digital copying machine 1 has an apparatus body 10, which houses a scanner unit 11 as read means and a color printer unit 12 serving as image forming means.

On the top of the body 10 an automatic document feeder (hereinafter referred to as ADF) 17 is provided so that it can be opened or closed. The ADF doubles as a document cover and automatically feeds sheet-like original documents one at a time. Instead of the ADF 17 a platen cover as a document cover may be attached. In the front portion of the top of the apparatus body 10 is provided an operating panel (not shown) equipped with various operating keys for instructing copy conditions and the start of copying and various displays.

A sensor 100 is attached to the apparatus body 100 in the vicinity of the ADF 17 to detect the opening or closing of the ADF 17. When the platen cover is set instead of the ADF 17, the sensor 100 will detect the opening or closing of the platen cover.

On the right-hand side of the apparatus body 10 are provided removably a paper feed cassette 57 which can hold a small quantity of paper and a large-capacity paper feed cassette 55 which can contain a large quantity of paper. The paper feed cassette 57 is provided with a manual feed tray 56 for feeding paper manually.

In the lower portion of the apparatus body 10 paper feed cassettes 52, 53 and 54 are provided removably. Each of these cassettes holds sheets of paper of the same size laterally or longitudinally. A selection can be made as required. On the left side of the apparatus body 10 is provided a finisher 80 for receiving finished copies.

On the top of the apparatus body 10 are placed a document table 13 made of transparent glass on which an object to be read, i.e., an original document, is placed and the ADF 17 for automatically feeding an original document onto the document table 13. The ADF 17 is arranged so that it can be opened or closed relative to the document table 13 and also functions as an original keep plate for keeping an original D in contact with the document table 13.

The ADF 17 includes a document tray 8 on which documents D are set, an empty sensor 9 for detecting the presence or absence of original documents, a pickup roller 14 for taking documents D from the document tray 8 one at a time, a feed roller 15 for transporting the original D taken out from the tray, paired aligning rollers 16 for positioning the leading edge of the original D, an aligning sensor (not shown) provided on the upstream side of the aligning rollers 16 for detecting the arrival of the original D, a size sensor (not shown) for detecting the size of the document D, and a carrier belt 18 placed to cover substantially the whole of the document table 13. The documents D placed in the document tray 8 with the image side up are taken out in sequence beginning with the bottommost one, i.e., the last page, then positioned by the aligning rollers 16 and transported to the desired position on the document table 13 by the carrier belt 18.

In the ADF 17, a reversing roller 20, a non-reversal sensor 21, a flapper 22 and a delivery roller 23 are placed on the opposite side of the carrier belt 18 to the paired aligning rollers 16. The original D having its image information read by the scanner 11 is moved from the document table 13 through the carrier belt 18 and then ejected onto a document delivery portion on the top of the ADF 17 through the reversing roller 20, the flapper 22, and the delivery roller 23.

To read the rear side of the document D, the flapper 22 is simply switched. Thereby, the document D transported by the carrier belt 18 is reversed by the reversing roller 20 and then transported to the predetermined position on the document table 13 again by the carrier belt 18.

The ADF 17 is equipped with a paper feed motor for driving the pickup roller 14, the paper feed roller 15, and the paired aligning rollers 16 and a carrier motor for driving the carrier belt 18, the reversing roller 20, and the delivery roller 23.

The scanner unit 11 in the apparatus body 10 has a light source, such as a fluorescent lamp, for illuminating the original D placed on the document table 13 and a first mirror 26 for deflecting reflected light from the document D in a predetermined direction. The light source 25 and the first mirror 26 are attached to a first carriage 27 placed below the document table 13. A size sensor 28 for detecting the size of the original placed on the document table 13 is mounted on the first carriage 27, which is arranged to be movable parallel to the document table 13 and reciprocated below the document table 13 by a driving motor through a toothed belt not shown.

A second carriage 29 movable parallel to the document table 13 is placed below the document table 13. The second carriage 29 is fitted with second and third mirrors 30 and 31 at right angles with respect to each other to deflect reflected light from the document D deflected by the first mirror 26 in turn. The second carriage 29 is driven by the toothed belt for driving the first carriage 27 to follow the first carriage and move parallel to the document table 13 at one half times the speed of the first carriage.

Below the document table 13 are placed an imaging lens 32 for focusing reflected light from the third mirror 31 on the second carriage 29 and a CCD sensor 34 for providing photoelectric conversion of reflected light focused by the imaging lens. The imaging lens is arranged so that it can move through a driving mechanism in a plane containing the optical axis of light deflected by the third mirror 31 and, by moving, images reflected light at a desired magnification. The CCD sensor 34 subjects incident reflected light to photoelectric conversion to output an electrical signal corresponding to the read document D.

The color printer unit 12 is equipped with a laser exposure device 40 acting as exposure means. The laser exposure device 40 is equipped with a semiconductor laser 41 as a light source, a polygon mirror 36 as a scanning member for deflecting continuously laser light emitted from the semiconductor laser 41, a polygon motor 37 as a scanning motor for rotating the polygon mirror 36 at a given rotating speed to be described later, and an optical system 42 for deflecting laser light from the polygon mirror 36 into photosensitive drums 44a through 44d to be described later. The laser exposure device 40 thus constructed is fixed to and supported by a support frame (not shown).

The on-off control of the semiconductor laser 41 is performed in accordance with image information from the document D read by the scanner unit 11. The laser light is directed through the polygon mirror 36 and the optical system 42 to the photosensitive drums 44a to 44d, so that their circumferential surfaces are scanned and electrostatic latent images are formed thereon.

The image forming unit 12 has rotatable photosensitive drums 44a to 44d as image bearing bodies which are arranged substantially in the center of the apparatus body 10. The desired electrostatic latent images are formed on the circumferential surfaces of the photosensitive drums 44a to 44d on exposure to laser light from the laser exposure device 40.

Around each of the photosensitive drums 44a to 44d are arranged in order an electrifying charger 45 for electrifying its circumferential surface to a given electric charge, a developer 46 for developing the electrostatic latent image formed on its surface at a desired image density by supplying tonor as developing powder to the latent image, a separation charger 38 for separating a transferred material (recording medium), i.e., copy paper P, from it, a transfer charger 48 for transferring the tonor image formed on it to the copy paper P, a separation claw (not shown) for separating the copy paper P from its surface, a cleaning device 50 for cleaning the residual tonor on its surface, and a charge eliminator 51 for eliminating charge on its surface.

The photosensitive drums 44a to 44d and their surrounding devices constitute the image forming units 45a to 45d.

In this example, the image forming units 45a to 45d are arranged in the order of Y, M, C, and BK since four colors of Y, M, C and BK images are superimposed upon one another from the upstream side in the direction in which the carrier belt 67 is moved, that is, in the direction in which the copy paper P is transported.

In the lower portion of the apparatus body 10 paper feed cassettes 52, 53 and 54 removable from the body are placed in a stacked form. Each of the cassettes holds sheets of copy paper P of a certain size. At the side of these cassettes 52, 53 and 54 is provided a large-capacity paper feed cassette 55 to contain frequently used copy paper, for example, about 3,000 sheets of copy paper of A4 size. Above the large-capacity paper feed cassette 55 is provided a removable paper feed cassette 57 which doubles as a manual feed tray 56.

In the apparatus body 10 is formed a paper path 58 which extends from each cassette through transfer sections located between the photosensitive drums 44a to 44d and the transfer chargers 48. At the end of the paper path 58 is provided a fixing device 60. In the wall of the apparatus body 10 opposite the fixing device 60 is formed an exit 61 to which a finisher 80 is attached.

In the vicinity of each of the cassettes 52, 53, 54, 55 and 57 is provided a pickup roller 63 which takes out sheets of copy paper one at a time from the corresponding cassette. Many paper feed roller pairs 64 are provided along the paper path 58 to transport copy paper P taken out by the pickup rollers 63 over the paper path.

Paired register rollers 65 are provided on the upstream side of the photosensitive drums 44a to 44d in the paper path 58. The paired register rollers 65 correct the inclination of copy paper P taken out, registers the leading edge of the tonor images on the photosensitive drums with the leading edge of the copy paper P, and feeds the copy paper P to the transfer sections at the same speed as the speed of the circumference surface of the drums. An aligning sensor 66 is provided short of the paired register rollers 65, i.e., on the paper feed roller side, which detects the arrival of the copy paper P.

Each sheet of copy paper P taken out from each cassette by means of the pickup roller 63 is fed to the paired register rollers 65 by the paired paper feed rollers 64. The copy paper is positioned by the paired register rollers 65 and then fed to the transfer sections by means of the carrier belt (transfer belt) 67.

In the transfer sections, the developing powder images, i.e., tonor images, formed on the photosensitive drums 44a to 44d are transferred to the copy paper P by means of the transfer chargers 48. The tonor image transferred copy paper P is separated from the drum surfaces by the separation chargers 47 and separation craws and then transported to the fixing device 60 on the carrier belt 67 forming a part of the paper path 58. The developing powder image is fused into the copy paper by the fixing device 60 and then ejected through the exit 61 into the delivery tray 81 of the finisher 80 by the paired feed rollers 68 and the paired delivery rollers 69.

Below the paper path 58 is provided an automatic double-side device (ADD) 70 which reverses the copy paper P passed through the fixing device 60 and then transports it again to the paired register rollers 65. The automatic double-side device 70 is equipped with a temporary collection section 71 which collects sheets of copy paper P temporarily, a reversal path 72 which reverses copy paper P branched from the paper path 58 and passed through the fixing device 60 and introduces it into the temporary collection section 71, a pickup roller 73 which takes out the sheets of copy paper P collected in the temporary collection section one at a time, and a paper feed roller 75 which feeds a sheet of paper taken out to the paired register rollers 65. A distribution gate 76 is provided between the paper path 58 and the reversal path 72, which selectively distributes the copy paper P to either the exit 61 or the reversal path 72.

For double-sided copying, the copy paper P passed through the fixing device 60 is introduced to the reversal path 72 by the distribution gate 76, then collected temporarily in the temporary collection section 71 and transported to the paired register rollers 65 through the pickup roller 73 and the paired register rollers 65. The copy paper P is positioned correctly by the register rollers 65 and then fed to the transfer sections where tonor images are transferred to the rear side of the copy paper P. After that, the copy paper P is transported into the delivery tray 81 through the paper path 58, the fixing device 60, and the delivery roller 69.

The use of the automatic double-side device 70 also allows copy paper to be ejected with its copied side down. That is, as in the case of double-sided copying, copy paper has an image transferred and fixed to its side, is collected temporarily in the collection section 71, transported on the carrier path 74 by the pickup roller 73 and the paper feed rollers 75, positioned by the register rollers 65, and transported into the delivery tray 81 through the carrier path 58, the fixing device 60 and the delivery roller 69.

In the front portion of the top of the apparatus body 10 is provided an operating panel (which will be described later) 91 to specify various copy conditions, such as copy magnification, etc., the start of copying (start key), etc.

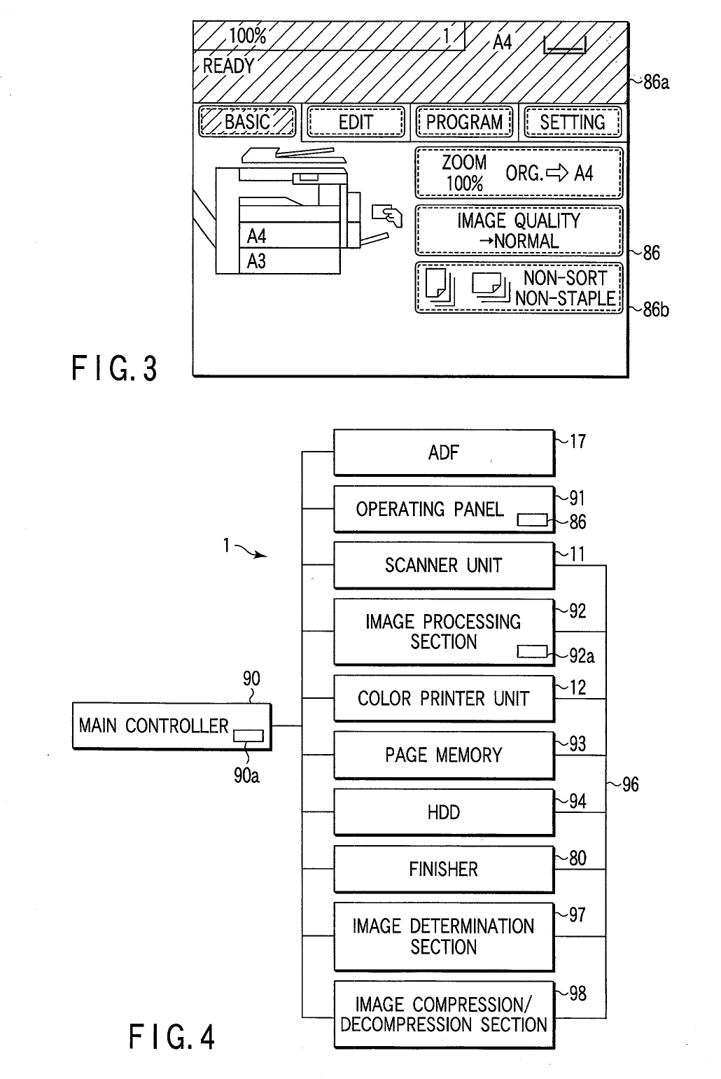

As shown in FIG. 3, the operating panel 91 has a liquid crystal display (LCD) 86 with built-in touch keys which provides an operator guide and through which various commands are given.

The liquid crystal display 86 is comprised of a guide display section 86a and a setting display section 86b. As shown in FIG. 3, the guide display section 86a displays operator guides, such as READY. The setting display section 86b provides switched display of various settings. In the example of FIG. 3, the setting display section 86b is the initial screen for setting the basic functions (BASIC). The example of FIG. 3 indicates settings of the selection of LCF 52, zoom (copy magnification), document size, image mode, sort or non-sort, and staple or non-staple. Commands, such as editing, program, setting change, etc., are each given by selecting a corresponding icon.

Next, the control system of the digital copying machine 1 will be described.

FIG. 4 is a block diagram of the control circuitry of the digital copying machine 1.

The digital copying machine 1 has a main controller 90 for controlling the whole machine. Although not shown, the main controller 90 includes a CPU (central processing unit), a ROM (Read only memory) storing software for operating the digital copying machine, and a RAM (random access memory) (S-RAM) 90a in which image data and operational data are temporarily stored.

The main controller 90 has the ADF 17, scanner unit 11, color printer unit 12, finisher 80, operating panel 91, image processing section 92, page memory 93, HDD 94, image determination section 97 and image compression/decompression section 98 connected to it by a bus 95. The image processing section 92, page memory 93, HDD 94, image determination section 97 and image compression/decompression section 98 are interconnected by an image bus 96.

The image processing section 92 processes document image data read by the scanner unit 11 and image data from the page memory 93, image compression/ decompression section 98 or HDD 94 and outputs processed image data to the page memory 93, image compression/decompression section 98, printer unit 12, or HDD 94.

The image processing section 92 has a color conversion section 92a, which converts image data of red, green and blue into image data of yellow, magenta, cyan, and black.

The image determination section 97 determines the condition of a document image on the basis of bit-mapped image corresponding to one original document developed in the page memory 93 or determines the most suitable setting (operation mode) in copying the original document. For example, the image determination section 97 decides the definition of the original document to determine the most suitable setting in forming the document image. The decision of whether the document image is a high-definition image or not is made on the basis of the sum (histogram) of the numbers of pixels of a predetermined density or more by scanning a line read by the scanner section 11, the distribution of density over the document image, or the amount of data from the entire document image. High-definition images include photographic images and fine design drawings and the like. Non-high-definition images include images consisting of character strings and the like.

The image compression/decompression section 98 compresses image data of each color from the page memory 93 according to the compression rate and the compression scheme (coding scheme) specified by the main controller 90 or decompresses image data from the HDD 94. For example, a data compression is formed by a first compression referred to as flanmeo for performing compression of data having a fixed-length data in before and after compression and a second compression for performing a information preserving coding.

The HDD 94 is an external storage device exemplified by a hard disk for storing various pieces of data.

The main controller 90 has a function for, upon determining that the start key on the operating panel has been pressed, drive controlling the scanner unit 11 to cause it to carry out prescan. In addition, the main controller 90 has a function for presenting to the user the most suitable settings, such as whether to compress a document image or not, in accordance with the results of a decision regarding the image type by the image determination section 97.

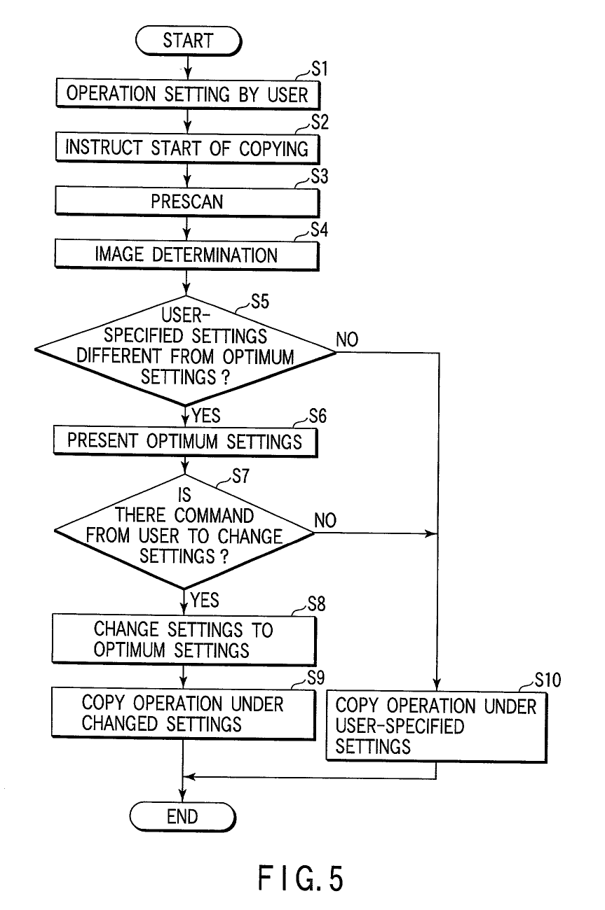

Next, in the arrangement as described above, the process of printing a color original document D will be described with reference to a flowchart shown in FIG. 5.

First, the user sets a color original document D on the document table and then enters various settings, such as image quality, density, the number of copies, etc., (setting of an operation mode) through the operating panel 91 (step S1). After having set the operation mode, the user presses the start key to instruct the start of copying (step S2).

When the start key is pressed, the main controller 90 carries out prescan of the color document D placed on the document table 13 through the scanner unit 11 (step S3). The image data read by this prescan is stored into the page memory 93.

The image determination section 97 determines the optimum operation mode on the basis of bit-mapped data for one document stored in the page memory 93 (step S4). For example, the image determination section 97 determines the most suitable operation mode to copy the document in accordance with the amount of data, the density or the density distribution. The result of the determination by the image determination section 97 is output to the main controller 90.

The main controller 90 makes a decision of whether or not the operation mode determined by the image determination section 97 differs from the operation mode specified by the user (step S5). If the result is that the operation mode specified by the user and the most suitable operation mode determined by the image determination section 97 differ (step S6), then the main controller 90 displays the most suitable settings determined by the image determination section 97 on the guide display section 86a of the operating panel 91 (step S7). In this case, for example, a guide to the effect that “Change settings to the most suitable settings?” is displayed or, of the settings specified by the user, only settings that differ from the most suitable settings are displayed with emphasis.

When such optimum settings are displayed, the user selects either copying based on the settings presented by the operating panel 91 or copying based on the user-specified settings. When the user selects copying based on the optimum settings through the operating panel, the main controller 90 changes various settings for copying to the settings determined by the image determination section 97 (step S8). When the settings are changed to the optimum settings, the main controller 90 carries out copying on the basis of the optimum settings (step S9).

When the user selects copying based on the settings specified by himself or herself through the operating panel 91, the main controller 90 carries out copying with the settings as specified by the user without changes to various settings for copying (step S10).

As described above, at the time of copying, prescan is carried out so as to determine the optimum setting for copying and present them to the user. This makes it possible to perform copying to fit user's intention with ease.

Also, at the time of copying, prescan is carried out to determine the optimum settings for copying and, when the user-specified settings differ from the optimum settings, the user is asked as to whether to change settings to the optimum settings or not. Thereby, the user is allowed to know the optimum settings with ease. Further, if the presented settings do not fit the user's intention, the user is allowed to perform copying with the user-specified settings. Thus, the user's convenience can be increased.

Next, as an example of such printing as described above, a description is given of an operation when the image determination section 97 makes a decision of whether or not a document image is unsuited for compression.

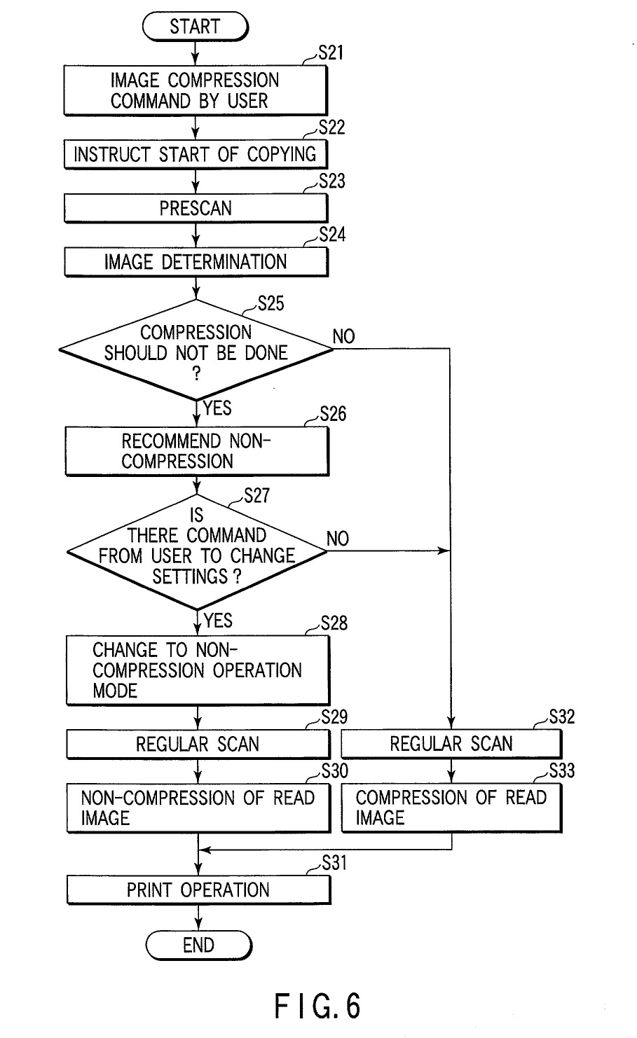

FIG. 6 is a flowchart for use in explanation of an operation of recommending the user copying without compression when the image should not be compressed.

First, the user sets a color original document D on the document table and then enters various settings, such as image quality, density, the number of copies, etc., (setting of an operation mode) through the operating panel 91. It is supposed that, at this point, the operation mode in which the read image is compressed is set (step S21). When, in this state, the user presses the start key to instruct the start of copying (step S22), the main controller 90 carries out prescan of the color document D placed on the document table 13 through the scanner unit 11 (step S23). The image data read by this prescan is stored into the page memory 93.

The image determination section 97 then makes a decision, on the basis of bit-mapped data for one original document stored in the page memory 93, of whether the document image should not be compressed or there is no problem in compressing the document image (step S24).

In general, compression of an image results in degradation of the image. For this reason, for high-definition images and complex images, such as photographic images, design drawings, etc., the image determination section 97 decides that compression should not be performed on images. On the other hand, for monotone images, such as images of character strings, and images of patterns which, when compressed, are less likely to degrade, the image determination section 97 decides that there is no problem in compressing images.

That is, the image determination section 97 makes a decision, on the basis of the amount of data, the density, and the density distribution of image data stored in the page memory 93, of whether the document image is a high-definition or complex image or not. According to the result of such a decision, the image determination section 97 decides whether to compress the document image or not.

The result of the decision by the image determination section 97 is output to the main controller 90. The main controller 90 then determines whether to compress or not (step S25).

If the determination is that compression should not be performed (YES in step S25), then the main controller 90 presents a guide to recommend copying without compression through the guide display section 86a of the operating panel 91 (step S27). In this case, for example, a display is made of a guide to the effect that the high quality (non-compression) mode is recommended in order to maintain the high quality; “Copy in high image quality mode?”.

When such a guide is presented, the user selects through the operating panel 91 between copying in high image quality (non-compression) mode and copying in compression mode specified by himself or herself.

When the user selects copying in high image quality (non-compression) mode through the operating panel 91, the main controller 90 changes the operation mode to the high image quality mode in which copying is performed without performing compression on the read image (step S28).

When the operation mode is changed to the high image quality mode in this manner, the main controller 90 reads the document image through the scanner unit 11 as the regular scan operation and stores the read image into the page memory 94 or the HDD 94 without compression (step S30). The image data stored into the page memory 93 or the HDD 94 in this way is printed onto an image formed medium by the printer unit 12 (step S31). The main controller 90 performs copying without compression through such operations.

When the user does not select copying without compression through the operating panel 91 or the determination in step S25 is that there is no problem in compression, the main controller 90 carries out the regular scan through the scanner unit 11 without changing the operation mode for the read image (step S32). The image read through this regular scan is compressed by the image compression/decompression section 98 and then stored into the HDD 94 (step S33). The image stored in the HDD 94 is read and decompressed by the image compression/decompression section 98 and printed onto paper by the printer unit 12 (step S31). The processes in steps S32, S33 and S31 causes the document image to be printed after compression and decompression.

The processes in steps S1 to S10 or steps S21 to S33 are performed on each original document D fed in sequence onto the document table 13 by the ADF 17. When two or more copies are specified for an original, the printing of the second copy and later is performed by reading image data from the HDD 94.

As described above, when an operation mode specified by the user or a preset operation mode involves compression, prescan is carried out at the time of copying to determine whether a document image should not be compressed or may be compressed. If the determination is that compression should not be done, the user is notified to the effect that compression should not be done. The user confirms the contents shown to select between compression and non-compression. Whether to perform compression or not is determined according to selection by the user.

Thereby, the optimum processing which suits the condition of a document image can be shown to the user. The user can readily select an optimum copying operation. A copying operation can be performed readily to fit the user's intention.

Additional advantages and modifications will readily occur to those skilled in the art. Therefore, the invention in its broader aspect is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
an operating unit for accepting an operation mode set command from a user;
a scanner unit for reading an original document image optically and converting it into image data;
an image determination section for determining the optimum operation mode for the image data read by the scanner unit;
a display unit for, when the operation mode determined by the image determination section and the operation mode specified by the user differ from each other, showing the operation mode determined by the image determination section;
a control unit for setting the operation mode determined by the image determination section when a command is given to change the operation mode to the operation mode shown on the display unit or setting the operation mode specified by the user through the operating unit when no command is given to change the operation mode to the operation mode shown on the display unit;
an image forming unit for performing image formation processing on the original document image read by the scanner unit on the basis of the operation mode set by the control unit.

2. The image forming apparatus according to claim 1, wherein the scanner unit is a color scanner and the image forming unit is a color printer.

3. The image forming apparatus according to claim 1, wherein the image determination unit determines the optimum settings for image formation of the original document image by the image forming unit on the basis of changes in density of the original document image read by the scanner unit.

4. The image forming apparatus according to claim 1, wherein the image determination unit determines the optimum settings for image formation of the original document image by the image forming unit on the basis of the amount of data from the original document image read by the scanner unit.

5. The image forming apparatus according to claim 1, wherein the image determination unit determines the optimum settings for image formation of the original document image by the image forming unit by determining whether or not the document image is a high-definition image on the basis of changes in density of the original document image read by the scanner unit.

6. An image forming apparatus comprising:
an operating unit for accepting an operation mode set command and a copy operation start command from a user;
a scanner unit for reading an original document image optically and converting it into image data;
a determination section for, when the copy operation start command is given through the operating unit, determining whether the document image read by the scanner unit is not suitable for compression and decompression;
a display unit for, when the determination section determines that the document image is not suitable for compression and decompression, showing a guide to the effect that compression and decompression processing should not be performed on the document image if the operation mode set by the user involves compression and decompression;
a control unit for setting an operation mode with no compression and decompression processing when it is told through the operating unit not to perform compression and decompression in accordance with the guide shown on the display unit and setting an operation mode with no compression and decompression processing when an operation mode with no compression and decompression processing is not told through the operating unit;
an image forming unit for forming the original document image read by the scanner unit on an image formed medium on the basis of the operation mode set by the control unit.

7. The image forming apparatus according to claim 6, wherein the scanner unit is a color scanner and the image forming unit is a color printer.

8. The image forming apparatus according to claim 6, wherein the image determination unit determines whether to compress and decompress the original document image or not on the basis of changes in density of the original document image read by the scanner unit.

9. The image forming apparatus according to claim 6, wherein the image determination unit determines whether to compress and decompress the document image or not on the basis of the amount of data from the original document image read by the scanner unit.

10. The image forming apparatus according to claim 6, wherein the image determination unit determines whether or not the document image is a high-definition image on the basis of changes in density of the original document image read by the scanner unit and, if the document image is a high-definition image, determines that compression and decompression processing should not be performed on the document image.

11. An image forming method used in an image forming apparatus including an operating unit for accepting an operation mode set command from a user, a scanner unit for reading an original document image optically and converting it into image data, and an image forming unit for forming the original document image read by the scanner unit on an image formed medium on the set operation mode, comprising:
determining the optimum operation mode for the image data read by the scanner unit;
when the determined operation mode differs from the operation mode specified by the user, showing the operation mode determined by the image determination section to the user;
setting the shown operation mode when a command is given to change the operation mode to the shown operation mode or setting an operation mode specified in advance by the user when no command is given to change the operation mode to the shown operation mode;
performing an operation of copying the original document image in the set operation mode.

12. The image forming method according to claim 11, wherein the scanner unit is a color scanner and the image forming unit is a color printer.

13. The image forming method according to claim 11, wherein determining the optimum operation mode is to determine the optimum settings for image formation of the original document image by the image forming unit on the basis of changes in density of the original document image read by the scanner unit.

14. The image forming method according to claim 11, wherein determining the optimum operation mode is to determine the optimum settings for image formation of the original document image by the image forming unit on the basis of the amount of data from the original document image read by the scanner unit.

15. The image forming method according to claim 11, wherein determining the optimum operation mode is to determine the optimum settings for image formation of the original document image by the image forming unit by determining whether or not the document image is a high-definition image on the basis of changes in density of the original document image read by the scanner unit.

16. An image forming method used in an image forming apparatus including an operating unit for accepting an operation mode set command and a copy operation start command from a user, a scanner unit for reading an original document image optically and converting it into image data, and an image forming unit for forming the original document image read by the scanner unit on an image formed medium in a set operation mode, comprising:
when the copy operation start command is given through the operating unit, reading the document image through the scanner unit and determining whether or not the document image is unsuitable for compression and decompression;
when the determination is that the document image is unsuitable for compression and decompression, showing a guide to the effect that compression and decompression processing should not be performed on the document image if an operation mode set by the user involves compression and decompression;
setting an operation mode with no compression and decompression processing when it is told through the operating unit not to perform compression and decompression in accordance with the guide shown and setting an operation mode with no compression and decompression processing when an operation mode with no compression and decompression processing is not told through the operating unit; and
performing an operation of copying the original document image in the set operation mode.

17. The image forming method according to claim 16, wherein the scanner unit is a color scanner and the image forming unit is a color printer.

18. The image forming method according to claim 16, wherein determining whether or not the document image is unsuitable for compression and decompression is to determine the original document image is unsuitable for compression and decompression on the basis of changes in density of the original document image read by the scanner unit.

19. The image forming method according to claim 16, wherein determining whether or not the document image is unsuitable for compression and decompression is to determine the original document image is unsuitable for compression and decompression on the basis of the amount of data from the original document image read by the scanner unit.

20. The image forming method according to claim 16, wherein determining whether or not the document image is unsuitable for compression and decompression is to determine whether or not the document image is a high-definition image on the basis of changes in density of the original document image read by the scanner unit and, if the document image is a high-definition image, determine that the original document image is unsuitable for compression and decompression.
